(19) United States
(12) Patent Application Publication
(10) Pub. No.: US 2003/0210009 A1
(43) Pub. Date: Nov. 13, 2003

(54) Pulse width modulated drive system for electronically commutated motors

(75) Inventor: Petre Minciunescu, North Andover, MA (US)

Correspondence Address: William R. McClellan, Wolf, Greenfield & Sacks, P.C., 600 Atlantic Avenue, Boston, MA, 02210, US

(73) Assignee: Analog Devices, Inc., Norwood, MA

(21) Appl. No.: 10/143,479

(22) Filed: May 10, 2002

(51) Int. Cl. G05B 11/28

(52) U.S. Cl. 318/599

(57) ABSTRACT

Drive systems and methods for energizing electronically commutated motors are provided. A drive system includes an inverter for providing pulse width modulated drive signals for energizing an electronically commutated motor in response to control signals and a controller for generating the control signals and for applying the control signals to the inverter such that winding pairs of the electronically commutated motor are energized in a selected sequence. The pulse width modulated drive signals include first and second pulses having first and second pulse widths, respectively, that are unequal. The average voltage applied to the energized winding pair is a function of the time difference between the first and second pulse widths.

### FIELD OF THE INVENTION

This invention relates to drive systems for electronically commutated motors and, more particularly, to improved pulse width modulated drive systems for electronically commutated motors.

### BACKGROUND OF THE INVENTION

Electronically commutated motor systems include an electronically commutated motor and a control system for energizing the motor. An electronically commutated motor typically includes a rotor having permanent magnets and a stator having a balanced three phase coil in the form of three motor windings. The control system includes a controller for generating pulse width modulated control signals and an inverter for energizing selected pairs of motor windings in response to the control signals. By energizing the motor windings in sequence, the rotor is caused to rotate.

A voltage applied to two of the motor windings produces a magnetic flux that interacts with the magnetic flux produced by the rotor, resulting in an electromagnetic torque which rotates the rotor. In the third open winding, the rotor magnetic flux induces an electromotive force that may be measured. The electromotive force is called “back emf”, and its amplitude depends on the motor speed and permanent magnet characteristics. The back emf is measured because it contains information regarding the rotor position and velocity.

By applying a variable voltage to the electronically commutated motor, a variable torque may be obtained and therefore the motor speed may be changed. The variable voltage is obtained by utilizing pulse width modulation (PWM) techniques. Pulse width modulation is a method to obtain a variable voltage using a DC supply voltage. By varying the duty cycle of the pulse width modulated control signal, the average voltage varies. In this way, a variable voltage may be applied to the motor windings.

A first prior art PWM modulation technique, known as soft chopping modulation, is shown in FIG. 9. A control period T is the time that each winding pair is energized during one rotation of the motor. Voltages V_{A} and V_{B} are the drive voltages applied to energized windings A and B, respectively. As shown, winding A is held at supply voltage V_{DC} during control period T, and winding B is pulsed to supply voltage V_{DC} for a time t₂. It may be shown that the average motor voltage Vₘ is proportional to the time t₁ during the control period T when the pulse on winding B is off.

The soft chopping modulation technique shown in FIG. 9 has the advantage that current passes through the inverter DC bus only during time t₁, which results in low current ripple and low power consumption. However, the prior art soft chopping modulation technique has disadvantages. The instantaneous and average values of the back emf depend on the voltage applied to the motor. This means that the back emf signal must be filtered in order to eliminate PWM harmonics. In addition, the flyback, which is a period after the commutation during which the current in the open phase decreases to zero, is unbalanced.

A second prior art PWM modulation technique, known as hard chopping modulation, is shown in FIG. 10. Winding A is pulsed to the supply voltage V_{DC} during time t₁, and winding B is pulsed to supply voltage V_{DC} during time t₂. The average voltage Vₘ applied to the motor is proportional to time t₁−t₂. The main difference between this modulation technique and the soft chopping modulation technique described above is that in the hard chopping modulation technique, current passes through the inverter DC bus at all times, because one winding is linked to supply voltage V_{DC} and the other winding is connected to ground during the entire control period.

The hard chopping modulation technique has the advantage that the back emf in the open phase is always symmetric with respect to V_{DC}/2. In addition, the flyback is constant during the entire revolution of the motor when the motor runs at constant speed and torque. A disadvantage of this approach is that current flows through the DC bus at all times, resulting in high current ripple and increased power consumption.

All of the known prior art pulse width modulation techniques for driving electronically commutated motors have one or more disadvantages. Accordingly, there is a need for improved pulse width modulated drive systems and methods for electronically commutated motors.

### SUMMARY OF THE INVENTION

According to a first aspect of the invention, a drive system is provided for an electronically commutated motor. The drive system comprises an inverter for providing pulse width modulated drive signals for energizing an electronically commutated motor in response to control signals and a controller for generating the control signals and for applying the control signals to the inverter such that winding pairs of the electronically commutated motor are energized in a selected sequence. The pulse width modulated drive signals comprise first and second pulses having first and second pulse widths, respectively, that are unequal. The average voltage applied to the energized winding pair is a function of the time difference between the first and second pulse widths.

Preferably, the midpoints of the first and second pulses are timed to occur approximately simultaneously, and the first and second pulses have the same polarity. Each of the winding pairs of the electronically commutated motor is energized for a control period T, and the first and second pulses may be substantially centered with respect to the control period T.

The controller may further comprise means for varying the first and second pulse widths of the first and second pulses to adjust the average voltage applied to the electronically commutated motor.

The inverter may comprise a circuit for connecting each winding of the electronically commutated motor to a supply voltage or to a reference voltage in response to the control signals.

According to another aspect of the invention, a method is provided for energizing an electronically commutated motor. The method comprises energizing pairs of windings of an electronically commutated motor with the pulse width modulated drive signals in a selected sequence. The pulse width modulated drive signals comprise first and second pulses having first and second pulse widths, respectively, that are unequal. The average voltage applied to the energized winding pair is a function of the time difference between the first and second pulse widths.

According to a further aspect of the invention, a motor system is provided. The motor system comprises an electronically commutated motor including a plurality of windings, an inverter for providing pulse width modulated drive signals for energizing the electronically commutated motor in response to control signals, and a controller for generating the control signals and for applying the control signals to the inverter such that winding pairs of the electronically commutated motor are energized in a selected sequence. The pulse width modulated drive signals comprise first and second pulses having first and second pulse widths, respectively, that are unequal. The average voltage applied to the energized winding pair is a function of the time difference between the first and second pulse widths.

### BRIEF DESCRIPTION OF THE DRAWINGS

For better understanding of the present invention, reference is made to the accompanying drawings, which are incorporated herein by reference and in which:

FIG. 1 is a schematic block diagram of an electronically commutated motor system in accordance with an embodiment of the invention;

FIG. 2 is a timing diagram that illustrates winding voltages and back emfs of the electronically commutated motor in accordance with an embodiment of the invention;

FIG. 3 is a equivalent circuit diagram of the electronically commutated motor;

FIG. 4 is a timing diagram of one control period T, illustrating pulse width modulated drive signals in accordance with a first embodiment to provide a relatively low motor voltage;

FIG. 5 is a timing diagram of one control period T, illustrating pulse width modulated drive signals in accordance with the first embodiment to provide an intermediate motor voltage;

FIG. 6 is a timing diagram of one control period T, illustrating pulse width modulated drive signals in accordance with the first embodiment to provide a relatively high motor voltage;

FIG. 7 is a timing diagram of one control period T, illustrating pulse width modulated drive signals in accordance with a second embodiment;

FIG. 8 is a flow diagram of a process for generating pulse width modulated control signals in accordance with an embodiment of the invention;

FIG. 9 is a timing diagram of one control period T, illustrating a prior art soft chopping modulation technique; and

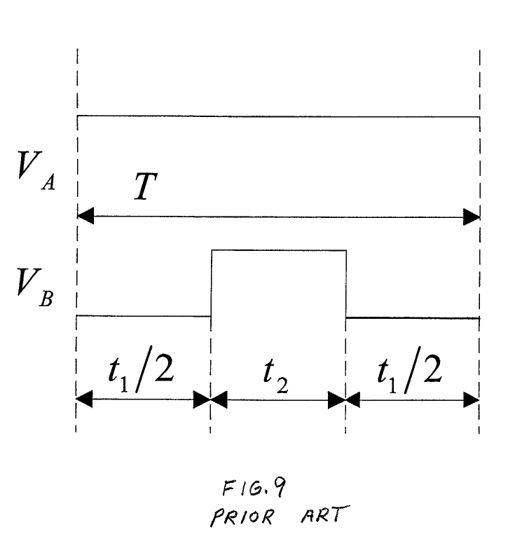

FIG. 10 is a timing diagram of one control period T, illustrating a prior art hard chopping modulation technique.

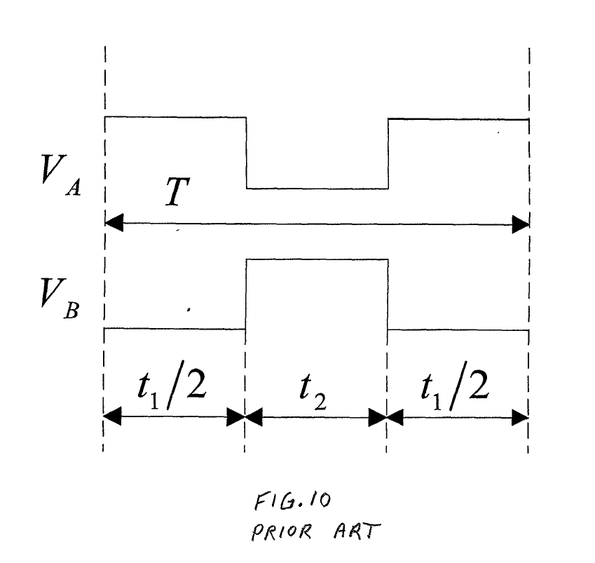

### DETAILED DESCRIPTION

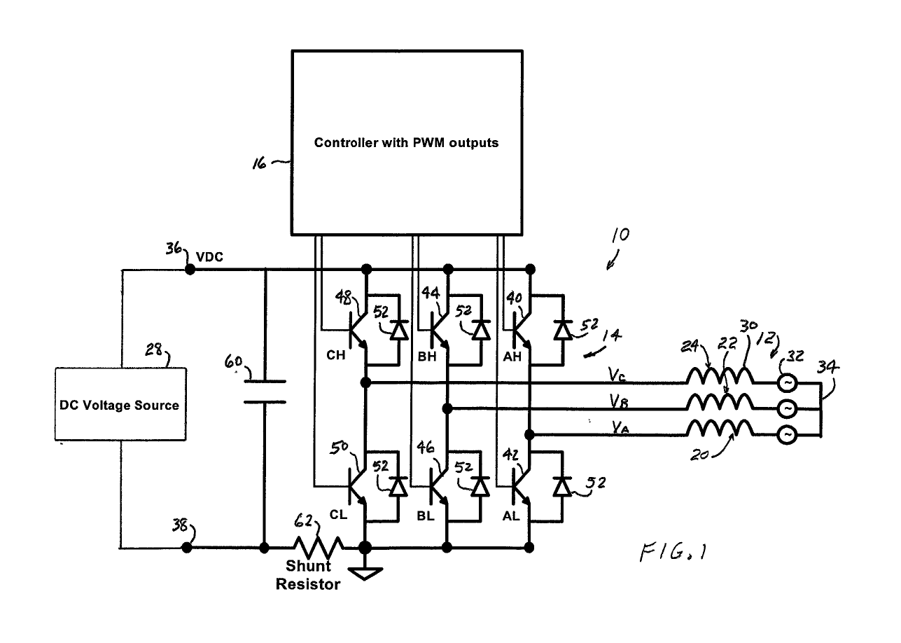

A block diagram of an embodiment of an electronically commutated motor system 10 is shown in FIG. 1. System 10 includes an electronically commutated motor 12, an inverter 14 for supplying drive signals to motor 12 and a controller 16 for supplying control signals to inverter 14.

Electronically commutated motor 12 includes a stator winding 20, a stator winding 22 and a stator winding 24. In FIG. 1, each winding is represented by an inductance 30 an a voltage generator 32. The inductance 30 represents the stator resistance and the stator inductance. Motor 12 also includes a rotor (not shown) having rotor magnets. The voltage generator represents the back emf induced in the winding by the rotor magnets. The windings 20, 22 and 24 are connected to a common node 34.

Inverter 14 includes circuitry for connecting each motor winding to a supply voltage V_{DC} or to a reference voltage, such as ground. A DC voltage source 28 provides supply voltage V_{DC} and is connected between a first terminal 36 and a second terminal 38 of inverter 14. Winding 20 may be connected by a power transistor 40 to supply voltage V_{DC} or may be connected by a power transistor 42 to ground. Winding 22 may be connected by a power transistor 44 to supply voltage V_{DC} or may be connected by a power transistor 46 to ground. Winding 24 may be connected by a transistor power 48 to supply voltage V_{DC} or may be connected by a power transistor 50 to ground. A free wheeling diode 52 is connected between the collector and the emitter of each of transistors 40-50. A capacitor 60 is connected between the first terminal 36 and the second terminal 38 of inverter 14, and a shunt resistor 62 is placed in the return path of inverter 14.

Transistors 40-50 are controlled by pulse width modulated control signals from controller 16 to energize motor 12. In particular, winding pairs are energized in a selected sequence to produce motor rotation. For example, by turning on transistor 40 and transistor 46, current flows through transistor 40, winding 20, winding 22 and transistor 46. Current flows in the opposite direction through windings 20 and 22 when transistors 44 and 42 are turned on. By appropriate control of transistors 40-50, winding pairs 20 and 22, 20 and 24, and 22 and 24 can be energized in sequence. When a winding pair is energized, the third of the three windings is open and the two transistors connected to that winding are turned off. Thus, for example, when windings 20 and 22 are energized, transistors 48 and 50 are off and winding 24 is open.

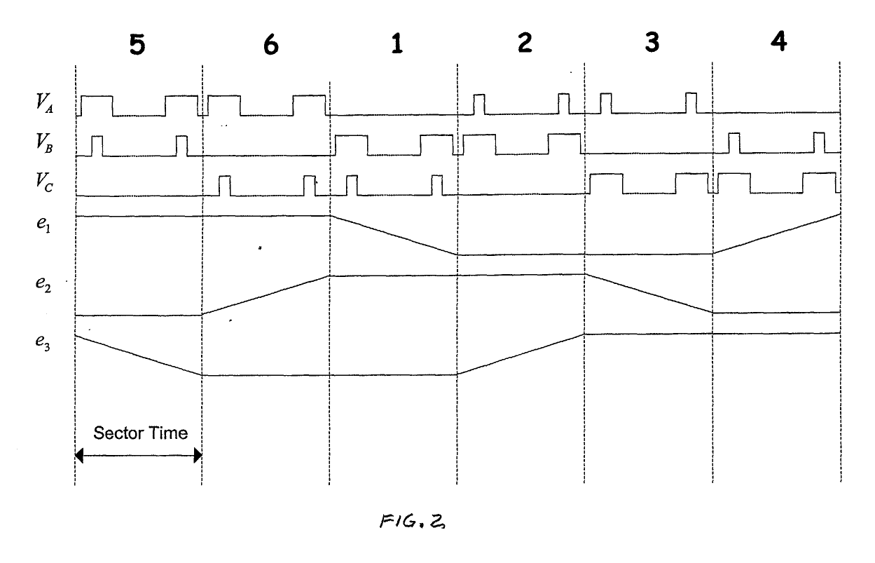

A timing diagram showing an example of winding drive voltages V_{A}, V_{B} and V_{C}, and corresponding back emfs e₁, e₂, and e₃ for one revolution of the rotor is shown in FIG. 2. Drive voltages V_{A}, V_{B} and V_{C} represent the voltages applied to stator windings 20, 22 and 24, respectively, and back emfs e₁, e₂ and e₃ represent the back emfs in stator windings 20, 22 and 24, respectively. Pulse width modulated winding voltages V_{A}, V_{B} and V_{C} are applied in a predetermined sequence during each control period T. Thus, in control period 5, windings 20 and 22 are energized; in control period 6, windings 20 and 24 are energized; in control period 1, windings 22 and 24 are energized; etc. The characteristics of the pulse width modulated signals applied to each energized winding pair determine the motor speed as described below. The back emf induced in each winding has a trapezoidal variation.

Assume that each of stator windings 20, 22 and 24 has two poles. When the rotor makes one complete turn, the emf induced in the stator windings completes one period. If the windings in the stator each have four poles, the situation changes. When the rotor makes one complete turn, the back emf induced in the stator windings completes two periods. Similarly, for stator windings having six poles, the back emf completes three periods, etc. FIG. 2 illustrates one period of the back emfs e₁, e₂ and e₃ This period may be divided into 6 sectors, each of 60°. In every sector, the pattern of the PWM pulses in different. For example, in sector 5 winding 24 is maintained open (the back emf induced in winding 24 varies in this sector) and voltages are applied to windings 20 and 22, with voltage V_{A} greater than voltage V_{B} (because back emf e₁ is greater than back emf e₂).

The sector time represents the time which the rotor stays in this sector, which may or may not represent 60° on the rotor, because the sector time is a function of the number of poles of the stator windings. If each winding has two poles, a back emf sector represents 60° on the rotor. If each winding has four poles, a back emf sector represent 30° on the rotor, etc. The sector time is a function of the rotor speed and therefore varies. Also, the number of PWM cycles in a sector varies as a function of rotor speed.

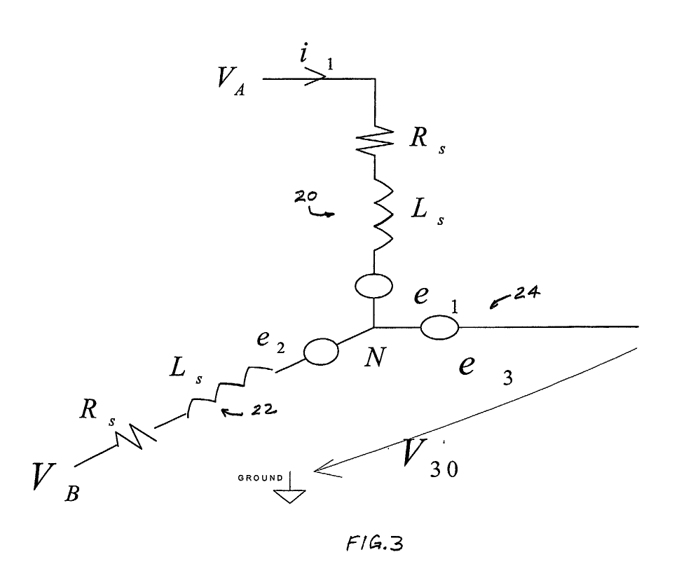

An equivalent circuit diagram of the motor during control period 5 is shown in FIG. 3. Winding 20 is energized by voltage V_{A}, winding 22 is energized by voltage V_{B}, and winding 24 is open (transistors 48 and 50 in FIG. 1 are both off). Winding 20 is represented by a resistance R_{S}, an inductance L_{S} and a back emf e₁. Winding 22 is represented by a resistance R_{S}, an inductance L_{S} and a back emf e₂. Winding 24 is represented by a back emf e₃, and the voltage between winding 24 and ground is represented by voltage V₃₀. The back emf e₃ is measured because it contains information regarding the rotor position and velocity.

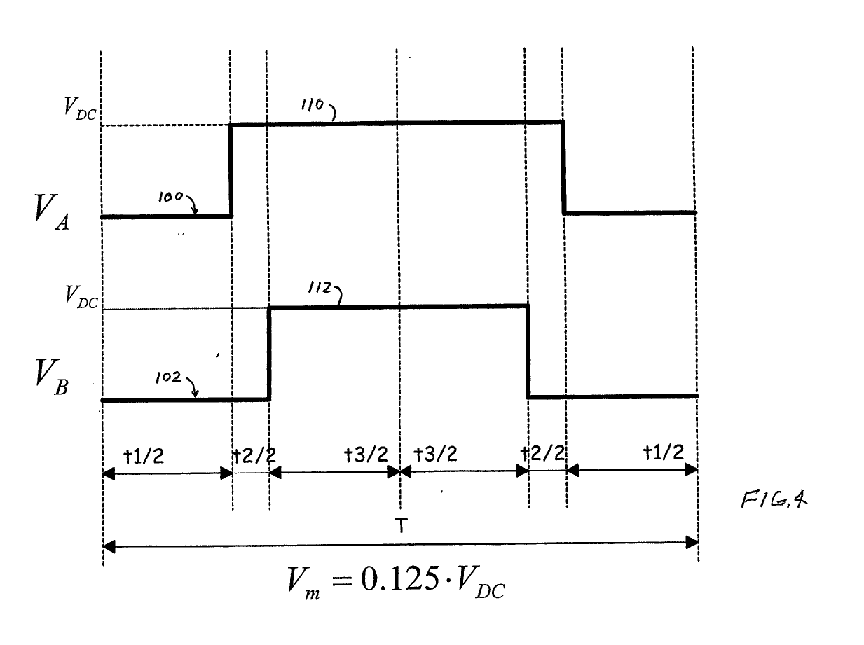

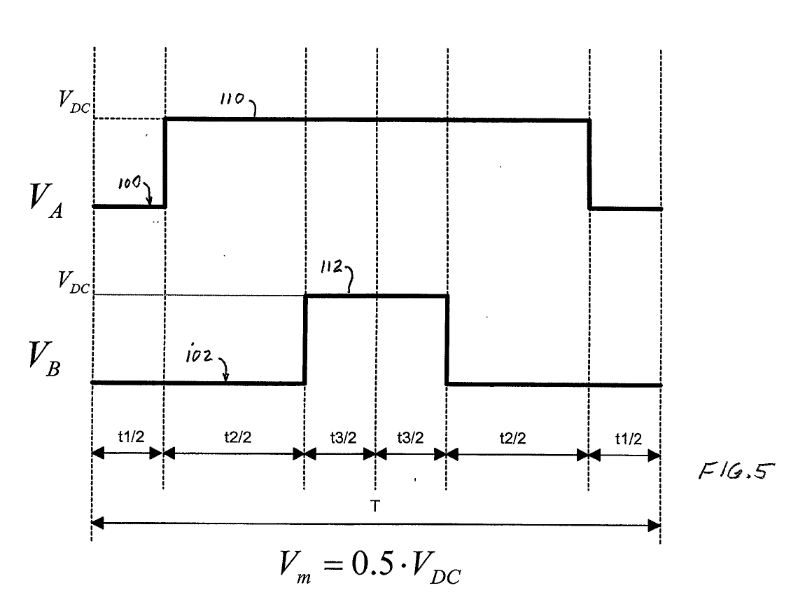

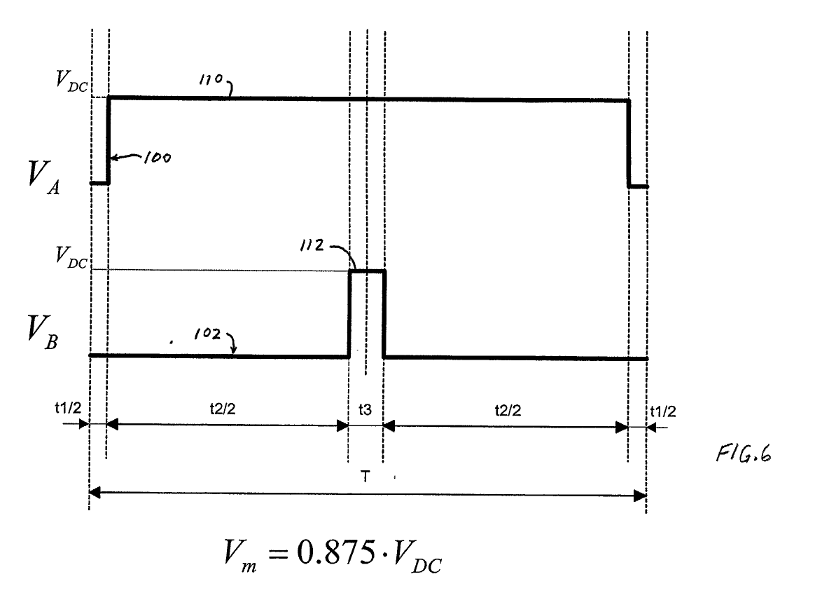

Waveforms for driving an electronically commutated motor in accordance with a first embodiment of the invention are shown FIGS. 4-6. A waveform 100 represents a drive voltage V_{A} applied to winding 20 (FIG. 1) during a control period T, and a waveform 102 represents a drive voltage V_{B} applied to winding 22 during the control period T. The control period illustrated in FIGS. 4-6 corresponds to control period 5 shown in FIG. 2. It will be understood that similar voltage waveforms are applied to other winding pairs during the other control periods as shown in FIG. 2. FIG. 4 represents a relatively low average motor voltage Vₘ (relatively small time t₂), FIG. 5 represents an intermediate average motor voltage Vₘ (intermediate time t₂), and FIG. 6 represents a relatively high average motor voltage Vₘ (relatively large time t₂).

As illustrated in FIGS. 4-6, winding 20 and winding 22 are both pulsed to supply voltage V_{DC} during a portion of control period T. In particular, waveform 100 includes pulse 110, and waveform 102 includes pulse 112. In FIGS. 4-6, time t₃ represents the width of pulse 112 applied to winding 22, and time t₂ represents the time difference between the widths of pulse 110 and pulse 112. Time t₁ represents the time during control period T when pulse 110 is off, or at ground. During time t₁, both windings 20 and 22 are connected to ground, and no current flows to or from DC voltage source 28. Similarly, during time t₃, both windings 20 and 22 are connected to supply voltage V_{DC}, and no current flows to or from DC voltage source 28. During time t₂, winding 20 is connected to supply voltage V_{DC} and winding 22 is connected to ground, resulting in current flow from the inverter through the windings. Accordingly, current flows through the A and B windings and the inverter only during time t₂, which corresponds to the time difference between pulse 110 and pulse 112.

Waveforms 100 and 102 may be generated by control signals applied to power transistors 40-50 as follows during times t₁, t₂, and t₃ of control period T. During time t₁, transistors 40, 44, 48 and 50 are off, and transistors 42 and 46 are on. During time t₂, transistors 42, 44, 48 and 50 are off, and transistors 40 and 46 are on. During time t₃, transistors 42 and 46, 48 and 50 are off, and transistors 40 and 44 are on. It will be understood that the above description of control signals applies to control period 5 shown in FIG. 2 and that different combinations of transistors 40-50 are turned on and off in other control periods.

As further illustrated in FIGS. 4-6, pulses 110 and 112 may be centered with respect to control period T. That is, the midpoint of pulse 110 and the midpoint of pulse 112 both occur at the midpoint of control period T. This holds true as the pulse widths are varied to adjust the average motor voltage Vₘ. As a result of the centering of pulses 110 and 112 in control period T, time t₂ is divided into two equal segments of time t₂/2.

The average voltages applied to windings 20 and 22 may be determined as follows.

$$\begin{matrix}{V}_{A} = {V}_{D C} \frac{{t}_{2} + {t}_{3}}{T} & ( 1 ) \\ {V}_{B} = {V}_{D C} \frac{{t}_{3}}{T} & ( 2 )\end{matrix}$$

where V_{A} and V_{B} represent the average voltages applied to windings 20 and 22, respectively. The motor voltage is given by

$${V}_{m} = {V}_{A} - {V}_{B} = {V}_{D C} \frac{{t}_{2}}{T} \qquad ( 3 )$$

where Vₘ represents the average voltage applied to the motor. In a typical application, the required motor voltage Vₘ is given, and from this value the widths of pulses 110 and 112 are determined. Referring the equation (3), the time t₂, which represents the time difference between pulses 110 and 112, can be determined from the given motor voltage Vₘ. Preferably, times t₁ and t₃ are made equal, and the values of times t₁ and t₃ are computed as follows:

$${t}_{1} = {t}_{3} = \frac{T - {t}_{2}}{2} \qquad ( 4 )$$

In the case where times t₁ and t₃ are equal, the average value of the back emf in the open winding is determined as follows:

$${e}_{3} = {V}_{30} - \frac{{V}_{D C}}{2} \qquad ( 5 )$$

where e₃ represents the back emf in the open winding and V₃₀ represents the voltage between the open winding and ground.

The pulse width modulation technique shown in FIGS. 4-6 and described above has the advantage that current flows through the inverter DC bus only during time t₂. This period is relatively small, so current ripple and power consumption are low. Another advantage is that the average value of the back emf in the open winding does not depend on motor voltage Vₘ and is symmetrical with respect to V_{DC}/2. It may be observed that the soft chopping modulation technique described above is a particular case of the modulation technique of FIGS. 4-6 if time t₁ is zero or time t₃ is zero. A disadvantage of the pulse width modulation technique shown in FIGS. 4-6 is that the instantaneous value of the back emf in the open winding is not symmetrical, thus requiring filtering to obtain the average value.

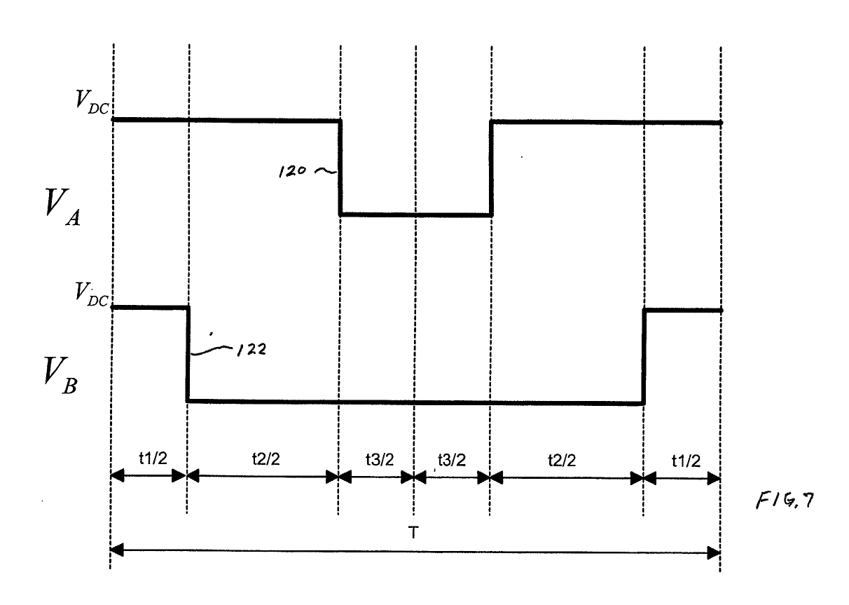

A second embodiment of the pulse width modulation technique in accordance with the invention is shown FIG. 7. As in FIGS. 4-6, a single control period T is shown in FIG. 7. In the embodiment of FIG. 7, the pulses are inverted with respect to the pulses shown in FIGS. 4-6. A pulse 120 is applied to winding 20, and a pulse 122 is applied to winding 22. Pulses 120 and 122 begin at the time when each winding is switched from supply voltage V_{DC} to ground. Pulse 120 has a pulse width of time t₃, and pulse 122 has a pulse width of time t₂+t₃. As in the embodiment of FIGS. 4-6, the average motor voltage is given by equation (3), and the back emf in the open winding is given by equation (5), for the case where time t₁ is equal to time t₃.

Controller 16 (FIG. 1) supplies pulse with modulated control signals to inverter 10 for applying pulse width modulated drive signals to electronically commutated motor 12, as shown in FIGS. 4-6 or FIG. 7 and described above. The control signals control each of transistors 40-50 to energize a selected winding pair according to the pulse width modulated drive signals described above. In a preferred embodiment, controller 16 is implemented as a programmed digital signal processor which generates control signals corresponding to a desired average motor voltage Vₘ. In one embodiment, controller 16 may be a type ADMCF328 sold by Analog Devices, Inc. However, it will be understood that different controller configurations may be utilized within the scope of the invention. For example, the control signals may be generated by any digital signal processor, microprocessor or microcontroller that is programmed to generate PWM signals. Furthermore, the control signals may be generated by special purpose or hardwired circuitry. These controller configurations are given by way of example only and are not limiting as to the scope of the invention.

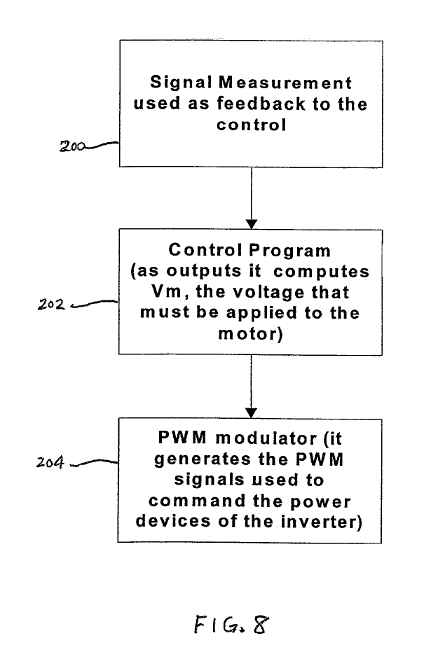

A flow chart of a process for generating pulse width modulated control signals is shown in FIG. 8. In step 200, a signal measurement is acquired for controlling motor 12. The signal measurement typically includes measurement of the voltage across shunt resistor 62 (FIG. 1) and the voltage on the open winding. The voltage across shunt resistor 62 represents the current through the return path of the inverter and is used to control the current in the motor windings. The voltage on the open winding is used to determine the velocity and position of the rotor. In step 202, the process determines the required motor voltage Vₘ to achieve a desired control function. In step 204, a pulse width modulation routine generates the pulse width modulated control signals to control power transistors 40-50 of inverter 10. In particular, the pulse width of pulse 112, which is time t₃, and the pulse width of pulse 110, which is time t₂+t₃, can be determined from equations (3) and (4) above, since supply voltage V_{DC} and control period T are known.

Having described this invention in detail, those skilled in the art will appreciate that numerous modifications may be made of this invention without departing from its spirit. Therefore, it is not intended that the breadth of the invention be limited to the specific embodiment illustrated and described. Rather, the breadth of the invention should be determined by the appended claims and their equivalents.

What is claimed:

1. A drive system for an electronically commutated motor, comprising:
an inverter for providing pulse width modulated drive signals for energizing an electronically commutated motor in response to control signals; and
a controller for generating the control signals and for applying the control signals to the inverter such that winding pairs of the electronically commutated motor are energized in a selected sequence, wherein the pulse width modulated drive signals comprise first and second pulses having first and second pulse widths, respectively, that are unequal, wherein the average voltage applied to the energized winding pair is a function of a time difference between the first and second pulse widths.

2. A drive system as defined in claim 1, wherein midpoints of said first and second pulses are timed to occur approximately simultaneously.

3. A drive system as defined in claim 1, wherein midpoints of said first and second pulses are timed to occur approximately simultaneously and wherein said first and second pulses have the same polarity.

4. A drive system as defined in claim 1, wherein each of the winding pairs of the electronically commutated motor is energized for a control period T and wherein said first and second pulses are substantially centered with respect to the control period T.

5. A drive system as defined in claim 1, wherein said controller comprises a programmed digital signal processor.

6. A drive system as defined in claim 1, wherein said controller further comprises means for varying the first and second pulse widths of the first and second pulses to adjust the average voltage applied to the electronically commutated motor.

7. A drive system as defined in claim 1, wherein said inverter comprises a circuit for connecting each winding of the electronically commutated motor to a supply voltage or to a reference voltage in response to said control signals.

8. A drive system as defined in claim 1, wherein said first and second pulses comprise pulses from ground to a supply voltage.

9. A drive system as defined in claim 1, wherein said first and second pulses comprise pulses from a supply voltage to ground.

10. A drive system as defined in claim 1, wherein said controller generates said first and second pulses during a control period T such that a time t₃ of said second pulse is equal to a time t₁ during the control period T that said first pulse is off.

11. A drive system as defined in claim 10, wherein a back emf e₃ generated by an open winding of the electronically commutated motor is given by
$${e}_{3} = {V}_{30} - \frac{{V}_{D C}}{2}$$
where V₃₀ is the voltage on the open winding and V_{DC} is a supply voltage connected to the inverter.

12. A drive system as defined in claim 1, wherein the average voltage Vₘ applied to the energized winding pair is given by
$${V}_{m} = {V}_{D C} \frac{{t}_{2}}{T}$$
where V_{DC} is a supply voltage connected to the inverter, T is a control period and t₂ is the time difference between the first and second pulse widths.

13. A method for energizing an electronically commutated motor, comprising:
energizing pairs of windings of an electronically commutated motor with pulse width modulated drive signals in a selected sequence, said pulse width modulated drive signals comprising first and second pulses having first and second pulse widths, respectively, that are unequal, wherein the average voltage applied to the energized winding pair is a function of a time difference between the first and second pulse widths.

14. A method as defined in claim 13, wherein the step of energizing pairs of windings comprises generating first and second pulses having midpoints that occur at substantially the same time.

15. A method as defined in claim 13, wherein the step of energizing pairs of windings comprises generating first and second pulses having the same polarity and having midpoints that occur at substantially the same time.

16. A method as defined in claim 13, wherein each pair of windings of the electronically commutated motor is energized for a control period T and wherein the step of energizing pairs of windings comprises generating first and second pulses having midpoints that are centered with respect to the control period T.

17. A method as defined in claim 13, wherein the step of energizing pairs of windings comprises generating control signals with a programmed digital signal processor and applying the control signals to an inverter to provide said pulse width modulated drive signals.

18. A method as defined in claim 17, wherein the step of generating control signals further comprises varying the first and second pulse widths of the first and second pulses to adjust the average voltage applied to the energized winding pair.

19. A method as defined in claim 13, wherein the step of energizing pairs of windings of the electronically commutated motor comprises connecting windings of the electronically commutated motor to a supply voltage or to a reference voltage.

20. A method as defined in claim 17, wherein the step of generating control signals comprises generating said first and second pulses during a control period T such that a time t₃ of said second pulse is equal to a time t₁ during the control period T that said first pulse is off.

21. A motor system comprising:
an electronically commutated motor including a plurality of windings;
an inverter for providing pulse width modulated drive signals for energizing said electronically commutated motor in response to control signals; and
a controller for generating the control signals and for applying the control signals to the inverter such that winding pairs of the electronically commutated motor are energized in a selected sequence, wherein the pulse width modulated drive signals comprise first and second pulses having first and second pulse widths, respectively, that are unequal, wherein the average voltage applied to the energized winding pair is a function of a time difference between the first and second pulse widths.

22. A motor system as defined in claim 21, wherein midpoints of said first and second pulses are timed to occur approximately simultaneously.

23. A motor system as defined in claim 21, wherein midpoints of said first and second pulses are timed to occur approximately simultaneously and wherein said first and second pulses have the same polarity.

24. A motor system as defined in claim 21, wherein each of the winding pairs of the electronically commutated motor is energized for a control period T and wherein said first and second pulses are substantially centered with respect to the control period T.

25. A motor system as defined in claim 21, wherein said controller comprises a programmed digital signal processor.

26. A motor system as defined in claim 1, wherein said controller further comprises means for varying the first and second pulse widths of the first and second pulses to adjust the average voltage applied to the electronically commutated motor.

27. A motor system as defined in claim 21, wherein said inverter comprises a circuit for connecting each winding of the electronically commutated motor to a supply voltage or to a reference voltage in response to said control signals.

28. A motor system as defined in claim 21, wherein said controller generates said first and second pulses during a control period T such that a time t₃ of said second pulse is equal to a time t₁ during the control period T that said first pulse is off.
